(19) United States
(12) Patent Application Publication
(10) Pub. No.: US 2024/0038463 A1
(43) Pub. Date: Feb. 1, 2024

(54) REINFORCED RUBBER DOME

(71) Applicant: INJECTION PRECISION RUBBER (SUZHOU) CO., LTD., SuZhou (CN)

(72) Inventors: Wei Zou, Pizhou (CN); Bohan Li, SuZhou (CN); Peiyun Zhang, SuZhou (CN)

(21) Appl. No.: 18/377,767

(22) Filed: Oct. 7, 2023

(30) Foreign Application Priority Data
Sep. 13, 2023 (CN) 202311183593.5

(51) Int. Cl. H01H 13/7065

(52) U.S. Cl. CPC H01H 13/7065

(57) ABSTRACT

The present disclosure discloses a reinforced rubber dome, including a support portion, an elastic connection portion, and a pressing portion connected in sequence, the support portion being provided with an exhaust groove penetrating inside and outside, and the pressing portion having a columnar triggering portion at an axially inner side thereof. An outer side wall of the elastic connection portion is further provided with elastic reinforcing bars, an inner wall of the elastic reinforcing bar is fitted on the outer side wall of the elastic connection portion, two ends of the elastic reinforcing bar are respectively connected to the support portion and the pressing portion. The reinforced rubber dome provided by the disclosure increases the strength of a pressing and bending area by arranging the elastic reinforcing bars of any number, any shape and any size on the outer side wall of the elastic connection portion.

### TECHNICAL FIELD

The present disclosure relates to the technical field of keyboards, and in particular to a reinforced rubber dome.

### BACKGROUND

As shown in FIG. 1, the conventional thin film keyboard for notebook computers mainly includes a keycap 30, an X-type bracket 40 disposed under the keycap 30 for fixing and stabilizing the keycap 30, and a rubber dome 10, and a thin film circuit switch 20 is also disposed at the bottom.

Referring to FIG. 2, the rubber dome 10 of the conventional structure of the above thin film keyboard has an inverted bowl shape, which mainly includes a support portion 11, an elastic connection portion 12 and a pressing portion 13, and the pressing portion 13 has a protruding triggering portion 131 at an axially inner side thereof, and the support portion 11 of the mouth of the bowl is installed on the thin film circuit switch 20 for supporting, and the pressing portion 13 of the bottom of the bowl is used for contacting the keycap 30. When the keycap 30 is pressed, an axially outer end of the pressing portion 13 of the rubber dome 10 first contacts the keycap 30 and is driven by the keycap 30 and is triggered downward along the axis, further, the triggering portion 131 at the axially inner end of the pressing portion 13 presses the thin film circuit switch 20 at the inner side to drive electrode contact points 21 in the thin film circuit switch 20 to contact each other to realize conduction, and is reset by the elastic connection portion 12 of the rubber dome 10 after the pressing is canceled, and then the pressing portion 13 is reset and the keycap 30 is driven to reset.

Since the rubber dome 10 of the prior art adopts a rubber material and is integrally shot molded in a mold cavity of an injection molding machine, the elastic connection portion 12 of the side wall is in a smooth annular shape with a certain slope, and the neck of the side wall (the connecting position of the elastic connection portion 12 and the pressing portion 13) will be bent and deformed when pressed. The disadvantage is that when the neck of the side wall is pressed and bent for many times, the bent place of the neck of the side wall will produce cracks 14 as shown in FIG. 3, resulting in abnormal rebound of the rubber dome 10, and even a breaking phenomenon leading to inability to rebound, and further causing the rubber dome 10 to lose the pressing and electrifying effect on the thin film circuit switch 20.

### SUMMARY

To solve the above technical problem, the present disclosure provides a reinforced rubber dome, including a support portion, an elastic connection portion, and a pressing portion connected in sequence, the support portion being provided with an exhaust groove penetrating inside and outside, and the pressing portion having a columnar triggering portion at an axially inner side thereof;

an outer side wall of the elastic connection portion is further provided with elastic reinforcing bars, an inner wall of the elastic reinforcing bar is fitted on the outer side wall of the elastic connection portion, two ends of the elastic reinforcing bar are respectively connected to the support portion and the pressing portion.

Wherein, at least two elastic reinforcing bars are provided and are disposed equally in an axial direction.

Wherein, the support portion, the elastic connection portion, the pressing portion, the triggering portion, and the elastic reinforcing bars are integrally formed using a rubber material.

The disclosure also provides a keyboard structure, including a thin film circuit switch, a rubber dome fitted on an upper surface of the thin film circuit switch, a keycap arranged on an upper end surface of the rubber dome, and an X-type bracket arranged under the keycap; wherein the rubber dome is the reinforced rubber dome of the above structure.

With the above technical solution, the reinforced rubber dome provided by the disclosure increases the strength of a bending area by arranging the elastic reinforcing bars of any number, any shape and any size on the outer side wall of the elastic connection portion, thereby effectively increasing the pressing times of the rubber dome and improving the service life of the keyboard.

### BRIEF DESCRIPTION OF FIGURES

In order to more clearly illustrate the technical solutions in the embodiments of the present disclosure or the prior art, the accompanying drawings which are required to be used in the description of the embodiments or the prior art will be briefly described below.

FIG. 1 is a schematic local axial cross-sectional diagram of a keyboard structure in the prior art;

FIG. 2 is a schematic diagram of an axial cross-sectional structure of a rubber dome of the prior structure in FIG. 1;

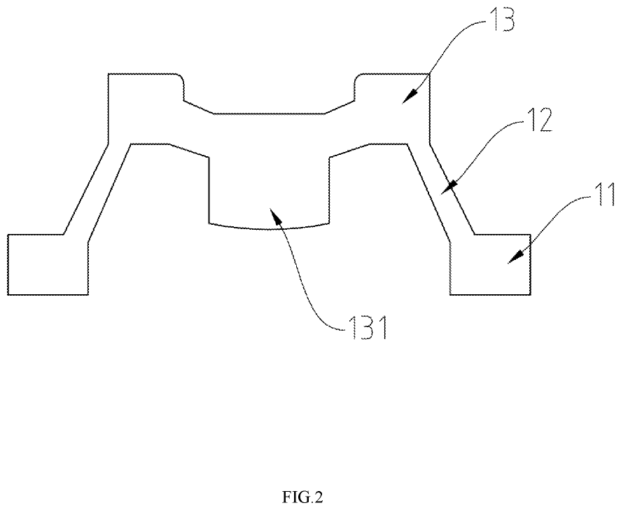

FIG. 3 is a schematic diagram of local rupture after pressing the rubber dome of the prior structure shown in FIG. 1

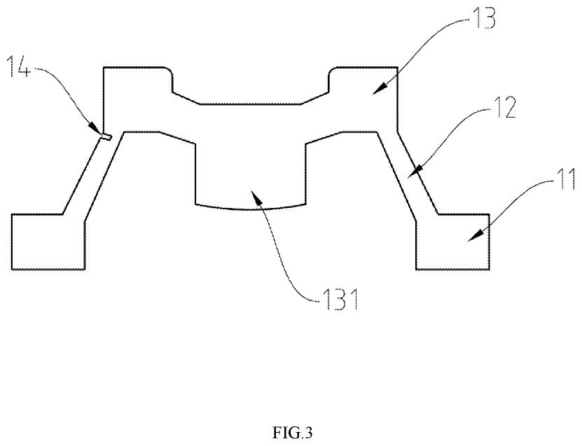

FIG. 4 is a schematic diagram of the main view structure of the reinforced rubber dome disclosed by the disclosure; and

FIG. 5 is a schematic diagram of the top view structure of the reinforced rubber dome disclosed by the disclosure.

The numbers in the figures represent: 10. rubber dome; 11. support portion; 12. elastic connection portion; 13. pressing portion; 131. triggering portion; 14. crack; 15. elastic reinforcing bar; 20. thin film circuit switch; 21. electrode contact point; 30. keycap; 40. X-type bracket.

### DETAILED DESCRIPTION

The following detailed description of the preferred embodiments of the present disclosure will be made with reference to the accompanying drawings so that the advantages and features of the present disclosure can be more readily understood by those skilled in the art, and thus the scope of the present disclosure will be more clearly defined.

### Embodiment 1

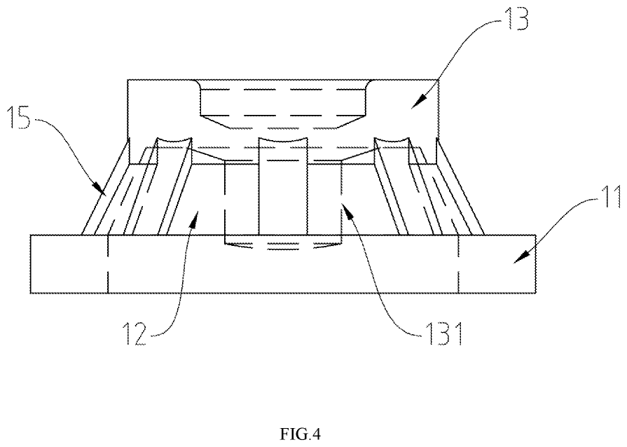

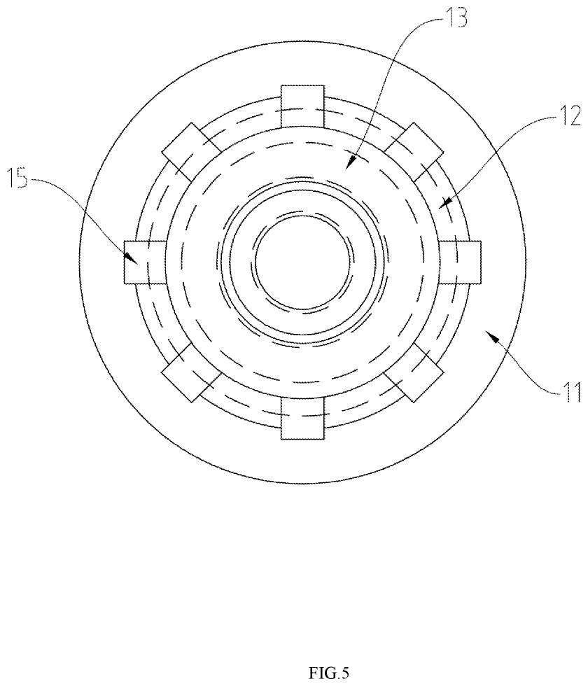

Referring to FIG. 4 and FIG. 5, Embodiment 1 provides a reinforced rubber dome, including a support portion 11, an elastic connection portion 12, and a pressing portion 13 connected in sequence, the support portion 11 being provided with an exhaust groove penetrating inside and outside, and the pressing portion 13 having a columnar triggering portion 131 at an axially inner side thereof; and
an outer side wall of the elastic connection portion 12 is further provided with elastic reinforcing bars 15 which are disposed equally in an axial direction, an inner wall of the elastic reinforcing bar 15 is fitted on the outer side wall of the elastic connection portion 12, two ends of the elastic reinforcing bar 15 are respectively connected to the support portion 11 and the pressing portion 13, and the support portion 11, the elastic connection portion 12, the pressing portion 13, the triggering portion 131, and the elastic reinforcing bars 15 are integrally formed using a rubber material.

The reinforced rubber dome provided by Embodiment 1 increases the strength of a bending area by arranging the elastic reinforcing bars 15 of any number, any shape and any size on the outer side wall of the elastic connection portion 12, thereby effectively increasing the pressing times of the rubber dome 10 and improving the service life of the keyboard.

In addition, since the elastic connection portion 12 of the side wall of the rubber dome 10 will bend when pressed, if the whole side wall is provided with the elastic reinforcing bars 15 to increase the pressing strength, when pressing, a large pressing force is needed to make the elastic connection portion 12 of the rubber dome 10 elastically deformed, and the rebound force generated when the rubber dome 10 rebounds is also increased, which will seriously affect the hand feeling of use. Therefore, the whole elastic connection portion 12 can be thinned, and the strength of the elastic connection portion 12 can be increased by the elastic reinforcing bars 15 of any number, any shape and any size on the outer wall of the elastic connection portion 12, which are thicker than the thickness of the elastic connection portion 12 after the whole thinning, so as to effectively compensate the pressing force and the rebound force lost after the whole thinning of the elastic connection portion 12, thereby effectively increasing the pressing times of the rubber dome 10 and improving the service life of the keyboard.

### Embodiment 2

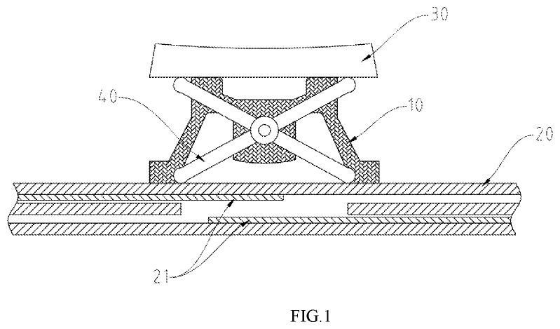

Referring to FIG. 1, Embodiment 2 provides a keyboard structure, the keyboard structure includes a thin film circuit switch 20, a rubber dome 10 fitted on an upper surface of the thin film circuit switch 20, a keycap 30 arranged on an upper end surface of the rubber dome 10, and an X-type bracket 40 arranged under the keycap 30; and
the rubber dome 10 is the reinforced rubber dome in Embodiment 1.

The previous description of the disclosed embodiments is provided to enable those skilled in the art to make or use the present disclosure. Various modifications to the above-described embodiments will be readily apparent to those skilled in the art, and the generic principles defined herein may be implemented in other embodiments without departing from the spirit or scope of the disclosure. Thus, the present disclosure is not intended to be limited to the embodiments shown herein but conforms to the widest scope consistent with the principles and novel features disclosed herein.

What is claimed is:

1. A reinforced rubber dome, comprising a support portion (11), an elastic connection portion (12), and a pressing portion (13) connected in sequence, the support portion (11) being provided with an exhaust groove penetrating inside and outside, and the pressing portion (13) having a columnar triggering portion (131) at an axially inner side thereof, wherein: an outer side wall of the elastic connection portion (12) is further provided with elastic reinforcing bars (15), an inner wall of the elastic reinforcing bar (15) is fitted on the outer side wall of the elastic connection portion (12), two ends of the elastic reinforcing bar (15) are respectively connected to the support portion (11) and the pressing portion (13).

2. The reinforced rubber dome according to claim 1, wherein at least two elastic reinforcing bars (15) are provided and are disposed equally in an axial direction.

3. The reinforced rubber dome according to claim 1, wherein the support portion (11), the elastic connection portion (12), the pressing portion (13), the triggering portion (131), and the elastic reinforcing bars (15) are integrally formed using a rubber material.

4. A keyboard structure, comprising a thin film circuit switch (20), a rubber dome (10) fitted on an upper surface of the thin film circuit switch (20), a keycap (30) arranged on an upper end surface of the rubber dome (10), and an X-type bracket (40) arranged under the keycap (30); wherein the rubber dome (10) is the reinforced rubber dome according to claim 3.
